(19) United States
(12) Patent Application Publication
(10) Pub. No.: US 2006/0099906 A1
(43) Pub. Date: May 11, 2006

(54) Satellite broadcast receiver for dividing power of satellite broadcast signal using wilkinson power divider

(75) Inventor: Bum-youl Bae, Daejeon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/983,587

(22) Filed: Nov. 9, 2004

(51) Int. Cl. H04H 1/00; H04B 1/10

(52) U.S. Cl. 455/3.02; 455/3.01

(57) ABSTRACT

A satellite broadcast receiver including a pre-amplifier to amplify and output a received satellite broadcast signal, a power division part to split the amplified satellite broadcase signal into first and second signals having first and second powers, respectively, using a Wilkinson power divider, a tuner to receive the first signal, and to tune and demodulate a signal of a certain frequency band, and a loopthrough part to output the second signal to the outside.

### BACKGROUND OF THE INVENTION

1. Field of the Invention

The present invention generally concerns a satellite broadcast receiver. More specifically, the present invention concerns a satellite broadcast receiver for receiving a broadcast signal emitted from an artificial satellite.

2. Description of the Related Art

Satellite broadcasting is accomplished through a geostationary satellite relaying a satellite broadcast signal, such as a broadcast signal for a television or a radio, transmitted from an earth station to enable an individual recipient or subscribers on a wide area to receive the signal. A satellite broadcast receiver receives the satellite broadcast signal emitted from the satellite.

In general, the satellite broadcast receiver tunes and receives the recipient's desired signal of a frequency band among satellite broadcast signals emitted from the satellite, and restores video and audio signals by demodulating the received signal. Furthermore, the satellite broadcast receiver bypasses and outputs the received signal to outside without incurring a loss, which is referred to as a loopthrough function.

FIG. 1 is a block diagram of a conventional satellite broadcast receiver. Referring to FIG. 1, the satellite broadcast receiver includes an antenna 10, a receiver 20, a pre-amplifier 30, an impedance matching network 40, a signal divider 45, a tuner 50, and a loopthrough part 60.

The antenna 10 receives the satellite broadcast signal in a frequency ranging from several GHz to tens of GHz from the satellite. The receiver 20 converts the received signal of the antenna 10 to a frequency of 950 MHz˜2150 MHz and outputs the converted signal to the pre-amplifier 30.

According to a specification on a power of the loopthrough, a power of the output signal bypassed through the loopthrough part 60 has to be ±3 dB of that of the input signal. To this end, the pre-amplifier 30 is employed, and is connected to an output port of the receiver 20. The pre-amplifier 30 amplifies and outputs the signal received from the receiver 20.

When an output port of one network is connected to an input port of another network, impedance matching is required to reduce reflection due to an impedance difference between the two different connection ports. In general, an impedance matching network is inserted between the two connection ports, and thus compensates the impedance difference of the connection ports. Impedances on the left and on the right based on the input port of the pre-amplifier 30 have to be matched, and impedances on the left and on the right based on the output port of the pre-amplifier 30 have to be matched.

The impedance matching network 40 is inserted between the output port of the pre-amplifier 30 and the input port of the tuner 50 and the loopthrough part 60, to obtain the impedance matching at the output port of the pre-amplifier 30.

The power of the satellite broadcast signal output from the impedance matching network 40 is divided into the tuner 50 and the loopthrough part 60 by the signal divider 45. It is not necessary to divide the power into halves. A signal with a power within 3 dB of the power of the input signal of the pre-amplifier 30 is input to the loopthrough part 60, and the rest is input to the tuner 50. Commonly, the signal divider 45 is constructed such that one line is split into two lines.

The conventional satellite broadcast receiver amplifies the received satellite broadcast signal at the pre-amplifier 30 and distributes the amplified signal into the tuner 50 and the loopthrough part 60 at the signal divider 45 through a T-junction. The output port of the pre-amplifier 30 is connected to the impedance matching network 40 for the impedance matching at the output port of the pre-amplifier 30. However, it is difficult to obtain the impedance matching by inserting the impedance matching network 40, since the satellite broadcast signal has a broadband characteristic. If the impedance matching is not suitably performed, the signals split into the tuner 50 and the loopthrough part 60 bring about interference, and the signal may be distorted.

### SUMMARY OF THE INVENTION

To address the above and/or other problems of the conventional arrangement, an aspect of the present invention provides a satellite broadcast receiver dividing and outputting a power of a satellite broadcast signal into a tuner and a loopthrough part by use of a Wilkinson power divider.

Additional aspects and/or advantages of the invention will be set forth in part in the description which follows and, in part, will be obvious from the description, or may be learned by practice of the invention.

To achieve the above and/or other aspects and features of the present invention, the satellite broadcast receiver comprises a pre-amplifier to amplify and output a received satellite broadcast signal; a power division part to split the amplified satellite broadcast signal into first and second signals having first and second powers, respectively, using a Wilkinson power divider; a tuner to receive the first signal, and to tune and demodulate a signal of a certain frequency band; and a loopthrough part to output the second signal to outside.

The power division part may comprise a power division controller to determine a power division ratio of the first and second powers.

The power division controller may comprises a first resistor connected between a first output port of the Wilkinson power divider and the tuner; and a second resistor connected between a second output port of the Wilkinson power divider and the loopthrough part.

The Wilkinson power divider may be a microstrip type.

The pre-amplifier may comprise an amplifier to amplify the received satellite broadcast signal according to a predetermined gain using a transistor; an impedance matching part to match an input impedance of the amplifier to a predetermined impedance; and a power supplier to supply a power to the amplifier.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of a conventional satellite broadcast receiver;

FIG. 2 is a block diagram of a satellite broadcast receiver dividing a power of a satellite broadcast signal by use of a Wilkinson power divider according to an embodiment of the present invention;

FIG. 3 is a view of the Wilkinson power divider of FIG. 2; and

FIG. 4 is a circuit diagram of the satellite broadcast receiver of FIG. 2.

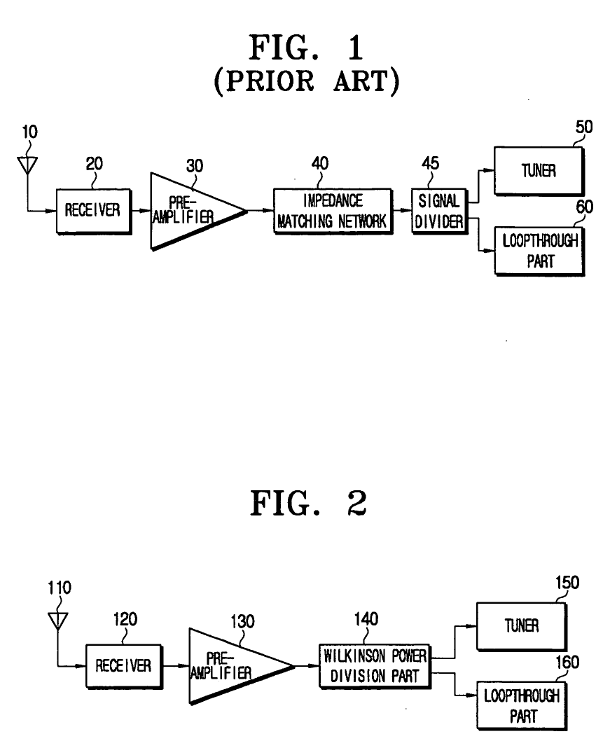

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the drawings.

FIG. 2 is a block diagram of a satellite broadcast receiver which divides a power of a satellite broadcast signal by use of a Wilkinson power divider according to an embodiment of the present invention. Referring to FIG. 2, the satellite broadcast receiver includes an antenna 110, a receiver 120, a pre-amplifier 130, a Wilkinson power division part 140, a tuner 150, and a loopthrough part 160.

The antenna 110 receives the satellite broadcast signal in a frequency ranging from several GHz to tens of GHz from a satellite. The receiver 120 down-converts the received signal of the antenna 10 to a frequency of approximately 950 MHz˜2150 MHz and outputs the converted signal to the pre-amplifier 130. The pre-amplifier 130 amplifies and outputs the satellite broadcast signal received from the receiver 120.

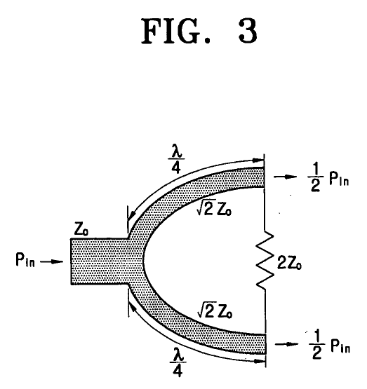

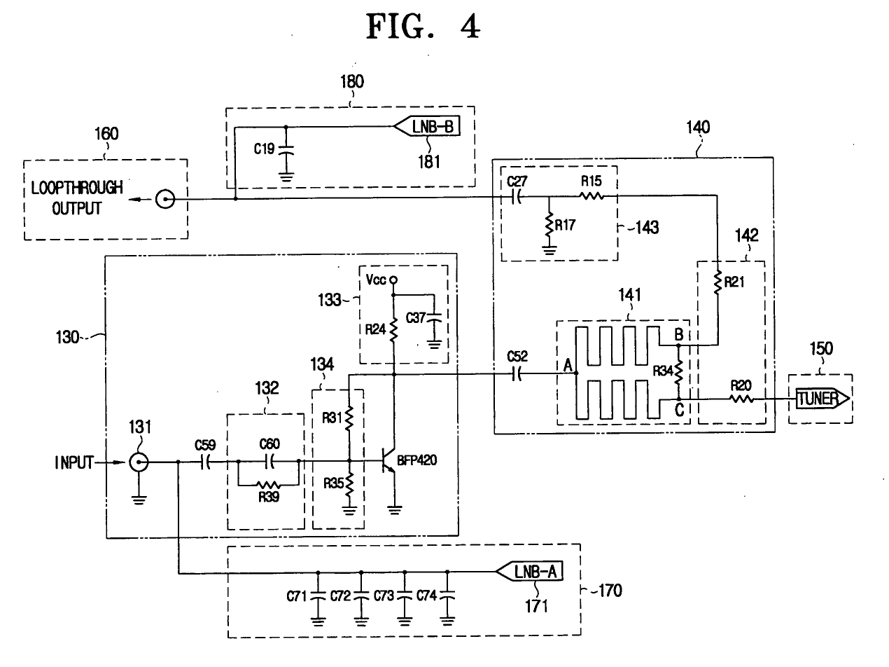

A power of the satellite broadcast signal amplified in the pre-amplifier 130 is divided and output to the tuner 150 and the loopthrough part 160 through the Wilkinson power division part 140. FIG. 3 depicts the Wilkinson power division part 140 of FIG. 2, which is described in detail below.

A power divider divides a power, that is, splits a single power signal into two or more power signals. The power divider is a kind of a coupler.

A simple T-junction power divider, which is used for a high frequency signal, divides the power into two paths, in which three ports are not completely matched. This is because there is no solution to compensate or convert any impedance difference between ports since the power divider having the T-junction line alone is a lossless structure. In addition, a lossless-loop may be generated, which may bring about oscillation as the frequency becomes higher.

To address the oscillation, a resistor is inserted between the two paths. In order to obtain a superior power division in a high frequency signal, an impedance balance between ports has to be maintained by realizing a power divider which produces a loss of signal power. The Wilkinson power divider is designed in consideration of the property of the high frequency signal. The Wilkinson power divider is in a microstrip form on a printed circuit board (PCB), and is used for the realization of the power divider.

Referring to FIG. 3, the Wilkinson power divider divides the power using a T-junction transmission line. A characteristic impedance of an incoming line is Z₀, and that of a split line is \sqrt{2}Z₀. A length of the split line is λ/4, and a register having a resistance of 2Z₀ is inserted between the output ports for the impedance matching. The Wilkinson power divider divides the power of the input signal into halves in FIG. 3, but the ratio of the power division is adjustable by connecting resistors having different resistance to the split lines, respectively.

Referring back to FIG. 2, the tuner 150 tunes a satellite broadcast signal of a certain frequency band among the satellite broadcast signals received from the Wilkinson power division part 140, demodulates the satellite broadcast signal of the tuned frequency band, and therefore, extracts a video signal and an audio signal. The loopthrough part 160 receives the portion of the satellite broadcast signal from the Wilkinson power division part 140 that bypasses the tuner 150, and outputs this signal portion as it is.

FIG. 4 is a circuit diagram of the satellite broadcast receiver of FIG. 2, and illustrates the pre-amplifier 130, the Wilkinson power division part 140, the tuner 150, and the loopthrough part 160. FIG. 4 further illustrates a low noise block down-converter (LNB)-A part 170 and an LNB-B part 180 to determine polarity of the satellite broadcast signal.

The pre-amplifier 130 includes an F-connector 131, a capacitor C59, an impedance matching part 132, a power supplier 133, a bias controller 134, and a bipolar transistor BFP420. The F-connector 131 receives the satellite broadcast signal. The capacitor C59 blocks a direct current (DC) flowing from the LNB-A part 170 to the pre-amplifier 130. The impedance matching part 132 includes a capacitor C60 and a resistor R39. The impedance matching part 132 matches the impedances of the output port of the receiver 120 and the input port of the pre-amplifier 130.

The power supplier 133 includes a Vcc power, a resistor R24, and a capacitor C37. The capacitor C37 is a bypass capacitor for removing noise components from the Vcc power. The bias controller 134 adjusts a voltage applied to a base of the bipolar transistor BFP420. The adjusted voltage determines the amplitude of the output signal at a collector of the bipolar transistor BFP420. The bipolar transistor BFP420 is an Rf bipolar transistor which amplifies the input signal, and its gain is 16 dB.

The Wilkinson power division part 140 includes a Wilkinson power divider 141, a power division controller 142, an impedance matching part 143, and a capacitor C52. The capacitor C52 blocks direct current from flowing to the Wilkinson power divider 141 from the Vcc power. The Wilkinson power divider 141 splits the incoming satellite broadcast signal into separate signals to be respectively sent to the tuner 150 and the loopthrough part 160. The incoming line of the Wilkinson power divider 141, which has a characteristic impedance is Z₀, is split into two lines each having a characteristic impedance of \sqrt{2}Z₀. The length of the respective split lines is λ/4. Hence, the characteristic impedances of the A˜B line and the A˜C line are \sqrt{2}Z₀, and their length is λ/4, respectively. A resistor R34 is inserted between the output ports of the Wilkinson power divider 141 for the sake of the impedance matching, and the resistance of the resistor R34 is 2Z₀.

The power division controller 142 includes two resistors R20 and R21. The resistor R20 is connected between the output port of the Wilkinson power divider 141 and the tuner 150, and the resistor R21 is connected between the output port of the Wilkinson power divider 141 and the impedance matching part 143. The ratio of the resistance values of the resistors R20 and R21 determines a power division ratio at which the Wilkinson power divider 141 splits the satellite broadcast signal. Accordingly, it is possible to adjust the ratio of the powers of the satellite broadcast signals to be respectively sent to the tuner 150 and the loopthrough part 160 by adjusting the ratio of the resistance values of the resistors R20 and R21.

The impedance matching part 143 includes a capacitor C27 and resistors R15 and R17, and performs the impedance matching at the output port of the Wilkinson power division part 140. The capacitor C27 blocks direct current from flowing from an LNB-B 181 to the Wilkinson power division part 140.

The LNB-A part 170 includes an LNB-A 171 and a plurality of capacitors C71 through C74. The LNB-A 171 is a circuit which determines the polarity of the satellite broadcast signal.

The LNB-B part 180 includes the LNB-B 181 and a capacitor C19. When the LNB-A part 170 is not in operation, the LNB-B 181 determines the polarity of the satellite broadcast signal input to the loopthrough part 160.

In light of the foregoing, the power of the satellite broadcast signal is divided and output to the tuner and the loopthrough part by use of the Wilkinson power divider, and the impedance matching network does not need to be provided at the output ports of the pre-amplifier. Accordingly, it is possible to obtain the impedance matching even though the satellite broadcast signal has the broadband characteristic. The interference of the signals, which arises in the event of the improper impedance matching, is prevented. In addition, the power loss due to the insertion of the impedance matching network is prevented. The power division ratio of the satellite broadcast signal can be easily adjusted by adjusting the ratio of the resistance values of the resistors connected to the output ports of the Wilkinson power divider.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A satellite broadcast receiver comprising:
a pre-amplifier to amplify and output a received satellite broadcast signal;
a power division part to split the amplified satellite broadcast signal into first and second signals having first and second powers, respectively, using a Wilkinson power divider;
a tuner to receive the first signal, and to tune and demodulate a signal of a certain frequency band; and
a loopthrough part to output the second signal to outside.

2. The satellite broadcast receiver of claim 1, wherein the power division part comprises a power division controller to determine a power division ratio of the first and second powers.

3. The satellite broadcast receiver of claim 2, wherein the power division controller comprises:
a first resistor connected between a first output port of the Wilkinson power divider and the tuner; and
a second resistor connected between a second output port of the Wilkinson power divider and the loopthrough part.

4. The satellite broadcast receiver of claim 3, wherein the first output port of the Wilkinson power divider outputs the first signal, and the second output port of the Wilkinson power divider outputs the second signal.

5. The satellite broadcast receiver of claim 3, wherein the power division ratio is adjusted by adjusting the ratio of the first and second resistors.

6. The satellite broadcast receiver of claim 1, wherein the power division part further comprises a capacitor to block direct current flowing to the Wilkinson power divider from a power source of the pre-amplifier.

7. The satellite broadcast receiver of claim 3, further comprising a resistor provided between the first and second output ports of the Wilkinson power divider to match impedance at the first and second output ports of the Wilkinson power divider.

8. The satellite broadcast receiver of claim 1, wherein the Wilkinson power divider is a microstrip type.

9. The satellite broadcast receiver of claim 1, wherein the pre-amplifier comprises:
an amplifier to amplify the received satellite broadcast signal according to a predetermined gain using a transistor;
an impedance matching part to match an input impedance of the amplifier to a predetermined impedance; and
a power supplier to supply a power to the amplifier.

10. The satellite broadcast receiver of claim 1, further comprising at least one low noise block down-converter to determine a polarity of the satellite broadcast signal.

11. A power division unit to divide a signal in a satellite broadcast receiver, the power division unit comprising:
a Wilkinson power divider to divide the signal into two portions to be respectively sent to a tuner and a loopthrough part of the satellite broadcast receiver; and
a power division controller to adjust a power division ratio of the two signal portions.

12. The power division unit of claim 11, wherein the power division controller comprises:
a first resistor connected between a first output port of the Wilkinson power divider and the tuner; and
a second resistor connected between a second output port of the Wilkinson power divider and the loopthrough part.

13. The power division unit of claim 11, further comprising an impedance matching part to match impedance at an output port of the power division unit.

14. The power division unit of claim 13, wherein the impedance matching part comprises a capacitor and a plurality of resistors.

15. The power division unit of claim 14, wherein the capacitor blocks direct current flowing from a low noise block down-converter of the satellite broadcast receiver.

16. The power division unit of claim 11, further comprising a capacitor to block direct current flowing to the Wilkinson power divider from a power source of a pre-amplifier of the satellite broadcast receiver.

17. A satellite broadcast receiver comprising:
a tuner to tune and demodulate a signal of a certain frequency band from a received first signal;
a loopthrough part to output a received second signal to outside of the satellite broadcast receiver; and
a Wilkinson power divider to divide power of a satellite broadcast signal into the first and second signals, and output the first and second signals respectively to the tuner and the loopthrough part.

18. The satellite broadcast receiver of claim 17, wherein a power division ratio of the first and second signals can be adjusted by adjusting a ratio of resistors connected to output ports of the Wilkinson power divider.
